(19) United States
(12) Patent Application Publication
(10) Pub. No.: US 2012/0140189 A1
(43) Pub. Date: Jun. 7, 2012

(54) Projection Display Apparatus

(75) Inventors: Yoshinao Hiranuma, Osaka (JP); Tomoya Terauchi, Osaka (JP); Susumu Tanase, Osaka (JP); Takaaki Abe, Osaka (JP); Masahiro Haraguchi, Osaka (JP); Noboru Yoshinobe, Osaka (JP)

(73) Assignee: Sanyo Electric Co., Ltd., Osaka (JP)

(21) Appl. No.: 13/307,796

(22) Filed: Nov. 30, 2011

(30) Foreign Application Priority Data
Nov. 30, 2010 (JP) 2010-267797

(51) Int. Cl. G03B 21/14

(52) U.S. Cl. 353/69

(57) ABSTRACT

A projection display apparatus includes: an imager; a projection unit; an acquisition unit; a shape correction unit that performs a shape correction process for projecting a shape correction pattern image on the projection plane, calculating shape correction values from the picked-up image of the shape correction pattern image, and correcting the shape of the image projected on the projection plane, based on the shape correction values; and a coordinate calibration unit that performs an interactive calibration process for projecting a calibration pattern image on the projection plane, calculating calibration correction values from the picked-up image of the calibration pattern image, associating coordinates of the picked-up image captured by the image pick-up element and coordinates of the image projected on the projection plane with each other, based on calibration correction values. The interactive calibration process is performed after the shape correction process.

### CROSS REFERENCE TO RELATED APPLICATIONS

This application is based upon and claims the benefit of priority from prior Japanese Patent Application No. 2011-122282 filed on Nov. 30, 2010; the entire content of which is incorporated herein by reference.

### BACKGROUND OF THE INVENTION

1. Field of the Invention

The present invention relates to a projection display apparatus including an imager that modulates light emitted from a light source, and a projection unit that projects light emitted from the imager on a projection plane.

2. Description of the Related Art

Conventionally, there is known a projection display apparatus including an imager that modulates light emitted from a light source, and a projection unit that projects light emitted from the imager on a projection plane.

Here, the shape of an image projected on a projection plane is distorted, depending on a position relationship between the projection display apparatus and the projection plane. Accordingly, there is known a technique of correcting the shape of the image projected on the projection plane, such as a keystone correction (hereinafter, “shape correction process”).

Meanwhile, in recent years, there is also proposed a technique of providing an interactive function by specifying coordinates indicated by an electronic pen or a hand on an image projected on a projection plane. More particularly, a projection plane is captured by an image pick-up element such as a camera, and based on a picked-up image of the projection plane, coordinates indicated by an electronic pen or a hand are specified (Japanese Unexamined Patent Application Publication 2005-92592, for example).

To provide such an interactive function, it is necessary to associate coordinates of the picked-up image captured by the image pick-up element (hereinafter, “C coordinates”) with coordinates of the image projected on the projection plane (hereinafter, “PJ coordinates”). In order to achieve the association between the coordinates, a calibration pattern image containing an image in which known PJ coordinates can be recognized is projected on the projection plane, and the calibration pattern image projected on the projection plane is captured by the image pick-up element. As a result, the known N coordinates and the C coordinates can be associated with each other (interactive calibration process).

However, if the association between the PJ coordinates and the C coordinates is completely established, and then, the above-described shape correction process is performed, then the association between the N coordinates and the C coordinates is collapsed. Therefore, it is not possible to appropriately provide the interactive function.

### SUMMARY OF THE INVENTION

A projection display apparatus (projection display apparatus 100) according to the first feature includes: an imager (liquid crystal panel) that modulates light emitted from a light source (light source 10); and a projection unit (projection unit 110) that projects the light emitted from the imager on a projection plane (projection plane 400). The projection display apparatus includes; an acquisition unit (acquisition unit 230) that acquires a picked-up image of an image projected on the projection plane from an image pick-up element (image pick-up element 300) that captures the image projected on the projection plane; a shape correction unit (shape correction unit 240) that performs a shape correction process for projecting a shape correction pattern image on the projection plane, calculating shape correction values from a picked-up image of the shape correction pattern image, and correcting the shape of the image projected on the projection plane, based on the shape correction values; and a coordinate calibration unit (coordinate calibration unit 260) that performs an interactive calibration process for projecting a calibration pattern image on the projection plane, calculating calibration correction values from the picked-up image of the calibration pattern image, associating coordinates of the picked-up image captured by the image pick-up element and coordinates of the image projected on the projection plane with each other, based on calibration correction values. The interactive calibration process is performed after the shape correction process.

In the first feature, the calibration pattern image includes an image in which a plurality of known coordinates can be specified, in the image projected on the projection plane. The plurality of known coordinates are dispersed separately from one another.

In the first feature, another image is superimposed on the calibration pattern image, in a region except for the image in which a plurality of known coordinates can be specified.

In the first feature, the calibration pattern image is the same as the shape correction pattern image. The coordinate calibration unit skips projection of the calibration pattern image during the interactive calibration process, when a correction amount of the shape of an image projected on the projection plane is equal to or less than a predetermined threshold value.

In the first feature, when a change amount of the attitude of the projection display apparatus falls within an acceptable range, the coordinate calibration unit performs a simple interactive calibration process for projecting a simple calibration pattern image on the projection plane, calculating calibration correction values from the picked-up image of the calibration pattern image, associating coordinates of the picked-up image captured by the image pick-up element and coordinates of the image projected on the projection plane with each other, based on calibration correction values. A region where the simple calibration pattern image is displayed is less than a region where the calibration pattern image is displayed.

In the first feature, the shape correction unit performs a simple shape correction process for projecting a simple shape correction pattern image on the projection plane, calculating shape correction values from the picked-up image of the shape correction pattern image, and correcting the shape of the image projected on the projection plane, based on the shape correction values. When a correction amount of the simple shape correction process falls within an acceptable range, the coordinate calibration unit performs a simple interactive calibration process for projecting a simple calibration pattern image on the projection plane, calculating calibration correction values from the picked-up image of the calibration pattern image, associating coordinates of the picked-up image captured by the image pick-up element and coordinates of the image projected on the projection plane with each other, based on calibration correction values. A region where the simple shape correction pattern image is displayed is less than a region where the shape correction pattern image is displayed. A region where the simple calibration pattern image is displayed is less than a region where the calibration pattern image is displayed.

### BRIEF DESCRIPTION OF THE DRAWINGS

FIG. 1 is a diagram illustrating an overview of a projection display apparatus 100 according to a first embodiment.

FIG. 2 is a diagram illustrating an overview of the projection display apparatus 100 according to the first embodiment.

FIG. 3 is a diagram illustrating a configuration example of an image pick-up element 300 according to the first embodiment.

FIG. 4 is a diagram illustrating a configuration example of the image pick-up element 300 according to the first embodiment.

FIG. 5 is a diagram illustrating a configuration example of the image pick-up element 300 according to the first embodiment.

FIG. 6 is a diagram illustrating the configuration of the projection display apparatus 100 according to the first embodiment.

FIG. 7 is a block diagram illustrating a control unit 200 according to the first embodiment.

FIG. 8 is a diagram illustrating one example of a shape correction pattern image according to the first embodiment,

FIG. 9 is a diagram illustrating one example of a shape correction pattern image according to the first embodiment.

FIG. 10 is a diagram illustrating one example of a shape correction pattern image according to the first embodiment.

FIG. 11 is a diagram illustrating one example of a shape correction pattern image according to the first embodiment.

FIG. 12 is a diagram illustrating one example of a shape correction pattern image according to the first embodiment.

FIG. 13 is a diagram illustrating one example of a visible light cut filter according to the first embodiment.

FIG. 14 is a diagram illustrating one example of a visible light cut filter according to the first embodiment.

FIG. 15 is a diagram for explaining specifying of a correction parameter according to the first embodiment.

FIG. 16 is a diagram for explaining specifying of a correction parameter according to the first embodiment.

FIG. 17 is a diagram for explaining specifying of a correction parameter according to the first embodiment.

FIG. 18 is a diagram for explaining specifying of a correction parameter according to the first embodiment,

FIG. 19 is a diagram for explaining specifying of a correction parameter according to the first embodiment.

FIG. 20 is a diagram for explaining an association between the C coordinates and the PJ coordinates according to the first embodiment.

FIG. 21 is a diagram for explaining a conversion from the C coordinates into the PJ coordinates according to the first embodiment.

FIG. 22 is a diagram for explaining a conversion from the C coordinates into the PJ coordinates according to the first embodiment.

FIG. 23 is a flowchart illustrating the operation of the projection display apparatus 100 according to the first embodiment.

FIG. 24 is a flowchart illustrating the operation of the projection display apparatus 100 according to the first embodiment.

FIG. 25 is a flowchart illustrating the operation of the projection display apparatus 100 according to the first embodiment.

FIG. 26 is a block diagram illustrating a control unit 200 according to a first modification.

FIG. 27 is a diagram illustrating one example of a simple calibration pattern image according to the first modification.

FIG. 28 is a diagram illustrating one example of a simple calibration pattern image according to the first modification.

FIG. 29 is a diagram illustrating one example of a simple calibration pattern image according to the first modification.

FIG. 30 is a flowchart illustrating the operation of the projection display apparatus 100 according to the first modification.

FIG. 31 is a flowchart illustrating the operation of the projection display apparatus 100 according to the first modification.

### MODES FOR CARRYING OUT THE INVENTION

Hereinafter, a projection display apparatus according to an embodiment of the present invention is described with reference to drawings. Note that in the descriptions of the drawing, identical or similar symbols are assigned to identical or similar portions.

However, it should be noted that the drawings are schematic m and ratios of respective dimensions and the like are different from actual ones. Therefore, the specific dimensions, etc., should be determined in consideration of the following explanations. Of course, among the drawings, the dimensional relationship and the ratio are different.

### Overview of Embodiments

A projection display apparatus according to an embodiment of the present invention includes an imager that modulates light emitted from a light source, and a projection unit that projects the light emitted from the imager on a projection plane. The projection display apparatus includes: an acquisition unit that acquires a picked-up image of an image projected on the projection plane from an image pick-up element for capturing the image projected on the projection plane; a shape correction unit that performs a shape correction process for projecting a shape correction pattern image on the projection plane, calculating shape correction values from the picked-up image of the shape correction pattern image, and correcting the shape of the image projected on the projection plane, based on the shape correction values; and a coordinate calibration unit that performs an interactive calibration process for projecting a calibration pattern image on the projection plane, calculating calibration correction values from the picked-up image of the calibration pattern image, associating coordinates of the picked-up image captured by the image pick-up element and coordinates of the image projected on the projection plane with each other, based on calibration correction values. The interactive calibration process is performed after the shape correction process.

In this embodiment, the interactive calibration process is performed after the shape correction process as described above, and therefore, it is possible to prevent the collapse of the association between the coordinates of a picked-up image captured by the image pick-up element (0 coordinates) and the coordinates of an image projected on the projection plane (PJ coordinates).

### First Embodiment

### (Overview of Projection Display Apparatus)

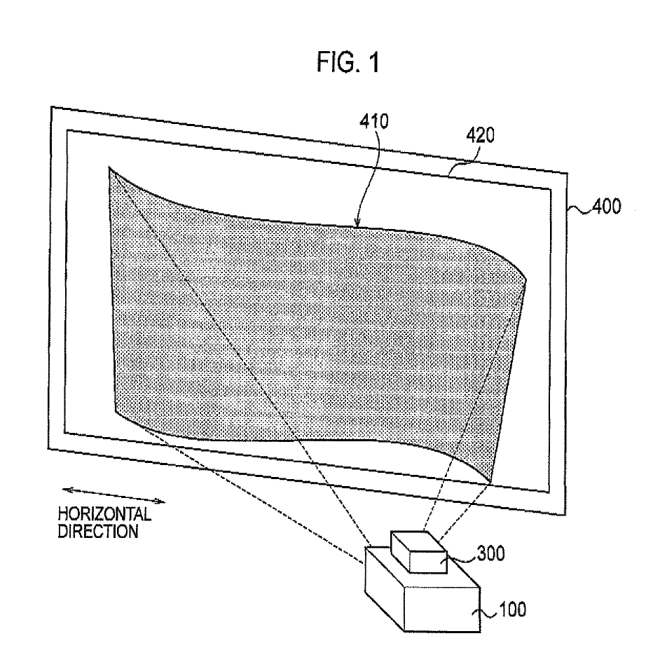

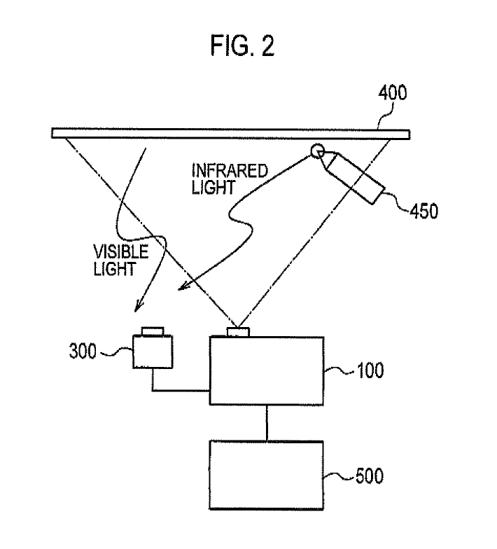

Hereinafter, an overview of the projection display apparatus according to a first embodiment is described with reference to drawings. FIG. 1 and FIG. 2 are diagrams illustrating an overview of the projection display apparatus 100 according to the first embodiment.

As illustrated in FIG. 1, in the projection display apparatus 100, an image pick-up element 300 is arranged. The projection display apparatus 100 projects the image light onto a projection plane 400.

The image pick-up element 300 captures the projection plane 400. That is, the image pick-up element 300 detects reflection light of the image light projected onto the projection plane 400 by the projection display apparatus 100. The image pick-up element 300 may be internally arranged in the projection display apparatus 100, or may be arranged together with the projection display apparatus 100.

The projection plane 400 is configured by a screen, far example. A range (projectable range 410) in which the projection display apparatus 100 can project the image light is formed on the projection plane 400. The projection plane 400 includes a display frame 420 configured by an outer frame of the screen,

The projection plane 400 may be a curved surface. For example, the projection plane 400 may be a surface formed on a cylindrical or spherical body. Alternately, the projection plane 400 may be a surface that may create barrel or pincushion distortions. Moreover, the projection plane 400 may be a flat surface.

In the first embodiment, the projection display apparatus 100 provides an interactive function. Specifically, the projection display apparatus 100 is connected to an external device 500 such as a personal computer, as illustrated in FIG. 2. The image pick-up element 300 detects reflection light (visible light) of the image projected on the projection plane 400 and infrared light emitted from an electronic pen 450.

The projection display apparatus 100 associates coordinates of a picked-up image of the image pick-up element 300 (hereinafter, “C coordinates”) with coordinates of an image projected on the projection plane 400 (hereinafter, “PJ coordinates”). Note that the PJ coordinates are the same as coordinates managed by the projection display apparatus 100 and the external device 500.

Furthermore, the projection display apparatus 100 converts coordinates indicated by the electronic pen 450 (i.e., the C coordinates of an infrared light beam in the picked-up image) into N coordinates, based on the association between the C coordinates and the PJ coordinates. The projection display apparatus 100 outputs the coordinates indicated by the electronic pen 450 (i.e., the PJ coordinates of the infrared light beam) to the external device 500.

### (Configuration of Image Pick-Up Element)

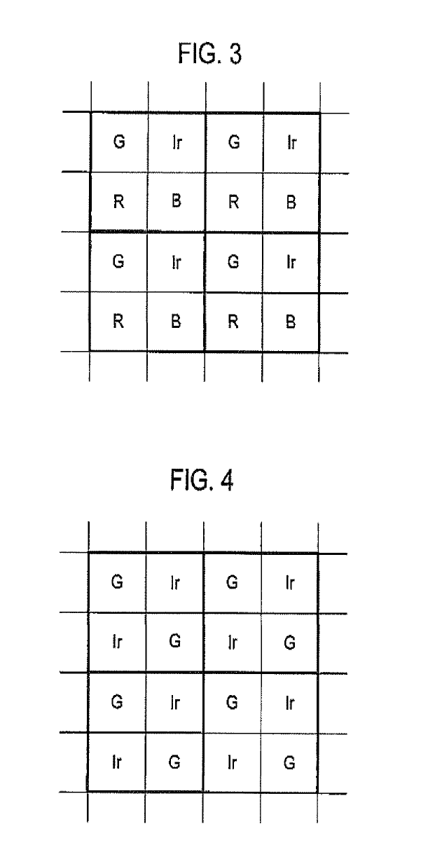

Hereinafter, the configuration of the image pick-up element according to the first embodiment is explained with reference to drawings. FIG. 3 to FIG. 5 illustrate the configuration example of the image pick-up element 300 according to the first embodiment. This image pick-up element 300 can detect visible light and infrared light.

For example, as illustrated in FIG. 3, the image pick-up element 300 may have an element R for detecting red component light R, an element G for detecting green component light G, and an element B for detecting blue component light B, and an element Ir for detecting infrared light Ir. That is, the image pick-up element 300 of FIG. 3 captures an image with a plurality of colors (full color image),

Alternatively, the image pick-up element 300 may have an element G for detecting green component light G and an element Ir for detecting infrared light Ir, as illustrated in FIG. 4. That is, the image pick-up element 300 illustrated in FIG. 4 captures an image of a single color (monochrome image).

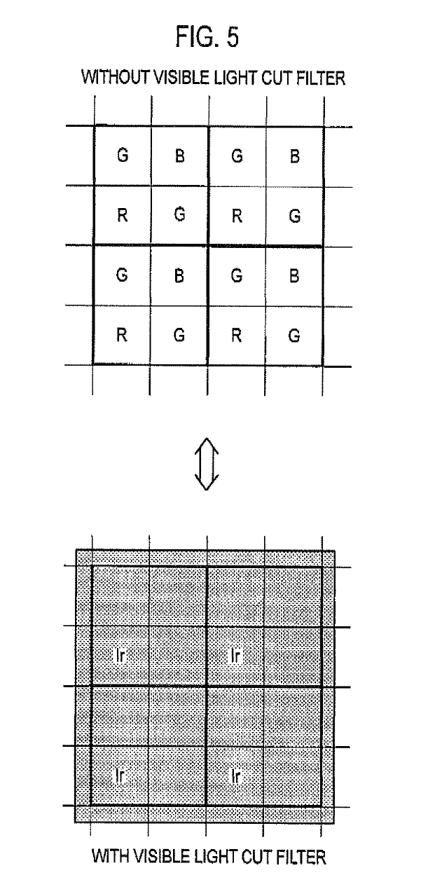

Alternatively, the image pick-up element 300 may switch between the detection of visible light and that of infrared light depending on the presence of a visible-light cut filter, as illustrated in FIG. 5. That is, the image pick-up element 300 detects the red component light R, the green component light G, and the blue component light B when the visible-light cut filter is not provided. Meanwhile, the image pick-up element 300 detects the infrared light Ir when the visible-light cut filter is provided. Note that the infrared light Ir is detected by the element R for detecting the red component light R.

### (Configuration of Projection Display Apparatus)

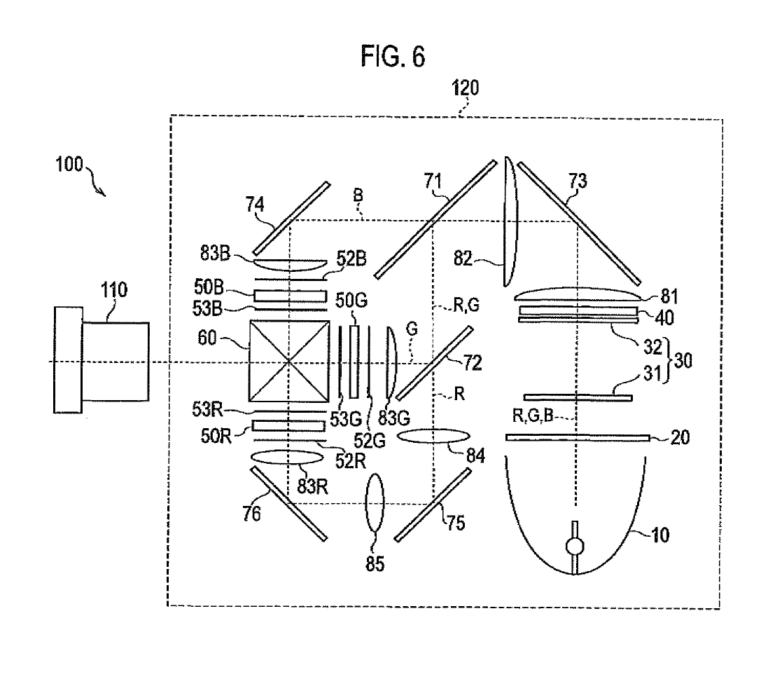

Hereinafter, the projection display apparatus according to the first embodiment is described with reference to drawings. FIG. 6 is a diagram illustrating the configuration of the projection display apparatus 100 according to the first embodiment.

As illustrated in FIG. 6, the projection display apparatus 100 includes a projection unit 110 and an illumination device 120.

The projection unit 110 projects the image light emitted from the illumination device 120, onto the projection plane (not illustrated), for example.

Firstly, the illumination device 120 includes a light source 10, a UV/IR cut filter 20, a fly eye lens unit 30, a PBS array 40, a plurality of liquid crystal panels 50 (a liquid crystal panel 50R, a liquid crystal panel 50G, and a liquid crystal panel 50B), and a cross dichroic prism 60.

Examples of the light source 10 include those (e.g., a UHP lamp and a xenon lamp) which outputs white light. That is, the white light output from the light source 10 includes red component light R, green component light G, and blue component light B.

The UV/IR cut filter 20 transmits visible light components (the red component light R, the green component light G, and the blue component light B). The UV/IR cut filter 20 blocks an infrared light component and an ultraviolet light component.

The fly eye lens unit 30 equalizes the light emitted from the light source 10. Specifically, the fly eye lens unit 30 is configured by a fly eye lens 31 and a fly eye lens 32. The fly eye lens 31 and the fly eye lens 32 are configured by a plurality of minute lenses, respectively. Each minute lens focuses light emitted from each light source 10 so that the entire surface of the liquid crystal panel 50 is irradiated with the light emitted from the light source 10.

The PBS array 40 makes a polarization state of the light emitted from the fly eye lens unit 30 uniform. For example, the PBS array 40 converts the light emitted from the fly eye lens unit 30 into an S-polarization (or a P-polarization).

The liquid crystal panel 50R modulates the red component light R based on a red output signal Rₒᵤₜ. At the side at which light is incident upon the liquid crystal panel 50R, there is arranged an incidence-side polarization plate 52R that transmits light having one polarization direction (e.g., S-polarization) and blocks light having the other polarization direction (e.g., P-polarization). At the side at which light is output from the liquid crystal panel 50R, there is arranged an exit-side polarization plate 53R that blocks light having one polarization direction (e.g., S-polarization) and transmits light having the other polarization direction (e.g., P-polarization).

The liquid crystal panel 50G modulates the green component light G based on a green output signal Gₒᵤₜ. At the side at which light is incident upon the liquid crystal panel 50G, there is arranged an incidence-side polarization plate 52G that transmits light having one polarization direction (e.g., S-polarization) and blocks light having the other polarization direction (e.g., P-polarization). On the other hand, at the side at which light is output from the liquid crystal panel 50G, there is arranged an exit-side polarization plate 53G that blocks light having one polarization direction (e,g., S-polarization) and transmits light having the other polarization direction (e.g., P-polarization).

The liquid crystal panel 50B modulates the blue component light B based on a blue output signal Bₒᵤₜ. At the side at which light is incident upon the liquid crystal panel 50B, there is arranged an incidence-side polarization plate 52B that transmits light having one polarization direction (e.g., S-polarization) and blocks light having the other polarization direction (e.g., P-polarization). On the other hand, at the side at which light is output from the liquid crystal panel 50B, there is arranged an exit-side polarization plate 53B that blocks light having one polarization direction (e.g., S-polarization) and transmits light having the other polarization direction (e.g., P-polarization).

The red output signal Rₒᵤₜ, the green output signal Gₒᵤₜ, and the blue output signal Bₒᵤₜ compose an image output signal. The image output signal is a signal to be output in a respective one of a plurality of pixels configuring one frame.

Here, a compensation plate (not illustrated) that improves a contrast ratio or a transmission ratio may be provided on each liquid crystal panels 50. In addition, each polarization plate may have a pre-polarization plate that reduces an amount of the light incident to the polarization plate or a thermal load.

The cross dichroic prism 60 configures a color combining unit that combines the light emitted from the liquid crystal panel 50R, the liquid crystal panel 50G, and the liquid crystal panel 50B. The combined light emitted from the cross dichroic prism 60 is guided to the projection unit 110.

Secondly, the illumination device 120 has a mirror group (mirror 71 to mirror 76) and a lens group (lens 81 to lens 85).

The mirror 71 is a dichroic mirror that transmits the blue component light B and reflects the red component light R and the green component light G. The mirror 72 is a dichroic mirror that transmits the red component light R and reflects the green component light G. The mirror 71 and the mirror 72 configure a color separation unit that separates the red component light R, the green component light G, and the blue component light B.

The mirror 73 reflects the red component light R, the green component light G, and the blue component light B and then guides the red component light R, the green component light G, and the blue component light B to the side of the mirror 71. The mirror 74 reflects the blue component light B and then guides the blue component light B to the side of the liquid crystal panel 50B. The mirror 75 and the mirror 76 reflect the red component light R and then guide the red component light R to the side of the liquid crystal panel 50R.

A lens 81 is a condenser lens that focuses the light emitted from the PBS array 40. A lens 82 is a condenser lens that focuses the light reflected by the mirror 73.

A lens 83R substantially collimates the red component light R so that the liquid crystal panel 50R is irradiated with the red component light R. A lens 83G substantially collimates the green component light G so that the liquid crystal panel 50G is irradiated with the green component light G. A lens 83B substantially collimates the blue component light B so that the liquid crystal panel 50B is irradiated with the blue component light B.

A lens 84 and a lens 85 are relay lenses that substantially form an image with the red component light R on the liquid crystal panel 50R while restraining expansion of the red component light R.

### (Configuration of Control Unit)

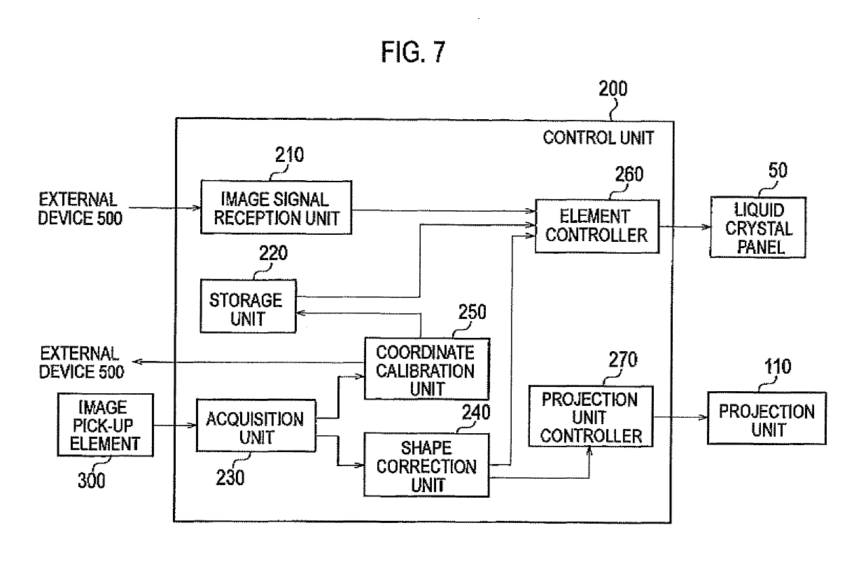

Hereinafter, the control unit according to the first embodiment will be described with reference to the accompanying drawings. FIG. 7 is a block diagram illustrating a control unit 200 according to the first embodiment. The control unit 200 is arranged in the projection display apparatus 100 and controls the projection display apparatus 100.

The control unit 200 converts the image input signal into an image output signal. The image input signal is configured by a red input signal Rᵢₙ, a green input signal Gᵢₙ, and a blue input signal Bᵢₙ. The image output signal is configured by a red output signal Rₒᵤₜ, a green output signal Gₒᵤₜ, and a blue output signal Bₒᵤₜ. The image input signal and the image output signal are a signal to be input in a respective one of a plurality of pixels configuring one frame.

As illustrated in FIG. 7, the control unit 200 includes: an image signal reception unit 210; a storage unit 220; an acquisition unit 230; a shape correction unit 240; a coordinate calibration unit 250; an element controller 260; and a projection unit controller 270.

The image signal reception unit 210 receives an image input signal from the external device 500 such as a personal computer,

The storage unit 220 stores a variety of information. Specifically, the storage unit 220 stores the shape correction pattern image used to correct an image to be projected on the projection plane 400. Also, the storage unit 220 stores the calibration pattern image used to associate the C coordinates with the PJ coordinates.

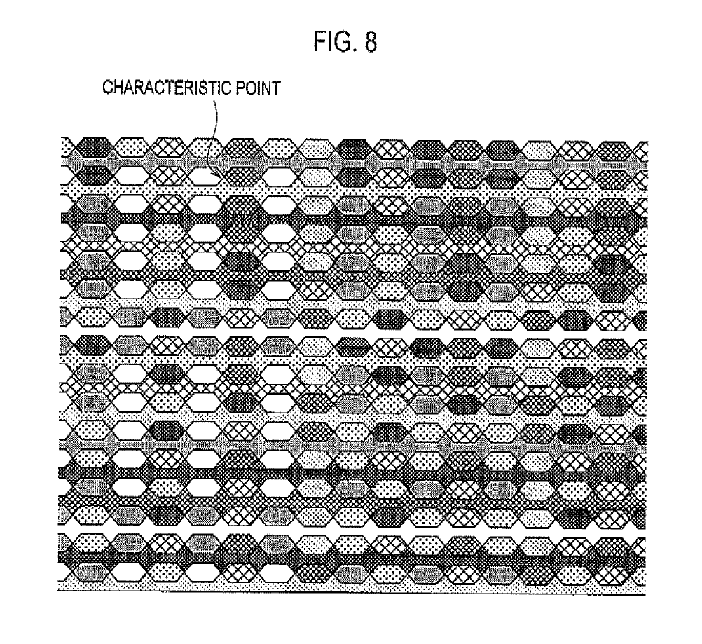

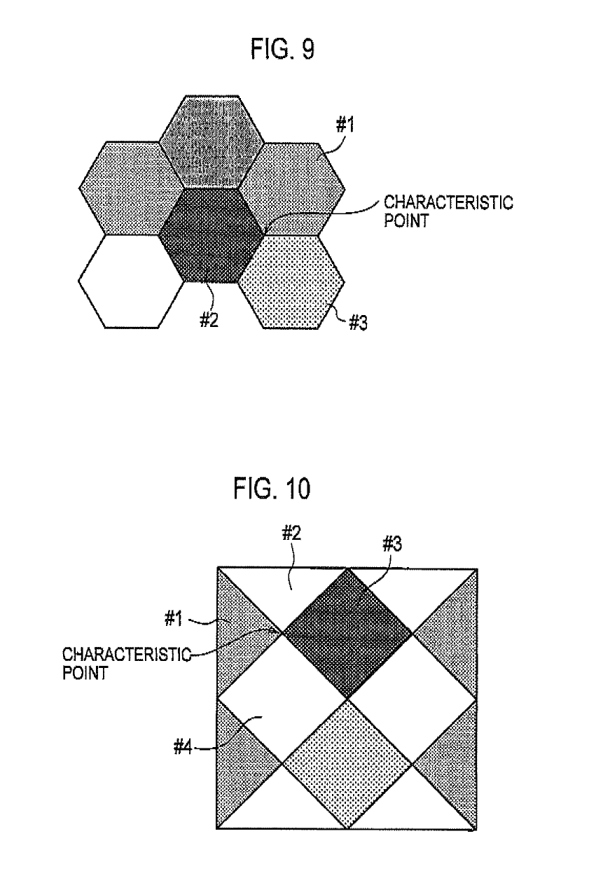

The shape correction pattern image is, for example, an image in which a characteristic point is defined by at least three adjacent regions, as illustrated in FIG. 8. Specifically, the shape correction pattern image is an image in which a characteristic point is defined by three hexagonal regions, as illustrated in FIG. 9. Alternatively, the shape correction pattern image is an image in which a characteristic point is defined by four rhombic regions, as illustrated in FIG. 10.

As illustrated in FIG. 9 or FIG. 10, the at least three adjacent regions surround the characteristic point, and are adjacent to the characteristic point. Further, of the at least three adjacent regions, a pair of respectively adjacent regions are different in luminance, chroma, or hue. For example, the at least three adjacent regions have information on a color selected from red, green, blue, cyan, yellow, magenta, white, and black.

As described above, the characteristic point is determined based on a combination of positions of adjacent regions defining the characteristic point and features (luminance, chroma, or hue) of the adjacent regions defining the characteristic point. The number of the characteristic points that can be determined without any overlap can be expressed by “ₙPₘ”, where “m” denotes the number of adjacent regions defining the characteristic point and “n” denotes the number of types of features (luminance, chroma, or hue) of adjacent regions defining the characteristic point, for example.

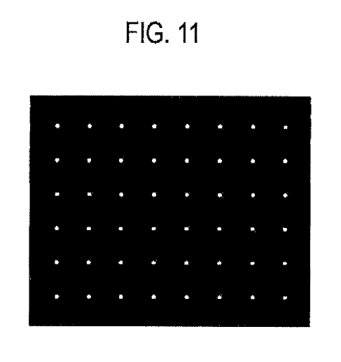

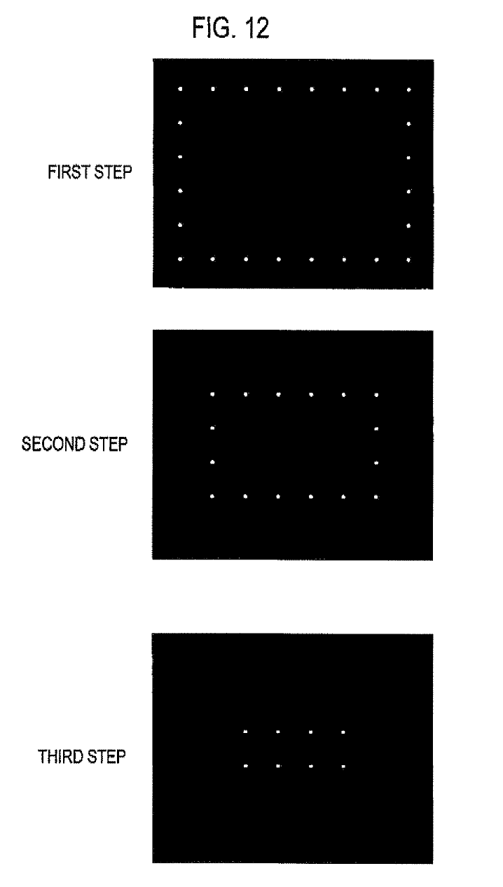

Alternatively, the shape correction pattern image may be an image containing a plurality of characteristic points (white polka dots) indicating known coordinates, as illustrated in FIG. 11. Moreover, the shape correction pattern image may be formed by dividing the image illustrated in FIG. 11 through a plurality of steps (in this case, a first to a third step), as illustrated in FIG. 12. Note that the image in each step is displayed in order.

Herein, the calibration pattern image is an image that can specify a plurality of known coordinates. It is preferable that the plurality of known coordinates be dispersed separately from one another. The images illustrated in FIG. 8 to FIG. 12 may be used as the calibration pattern image. The calibration pattern image may be different from the shape correction pattern image. Further, the calibration pattern image may be the same as the shape correction pattern image.

The acquisition unit 230 acquires a picked-up image from the image pick-up element 300. For example, the acquisition unit 230 acquires a picked-up image of the shape correction pattern image that is output from the image pick-up element 300. The acquisition unit 230 acquires a picked-up image of the calibration pattern image that is output from the image pick-up element 300. The acquisition unit 230 acquires a picked-up image of infrared light emitted from the electronic pen 450.

The shape correction unit 240 performs the shape correction process for projecting the shape correction pattern image on the projection plane 400 and correcting the shape of an image projected on the projection plane 400, based on the picked-up image of the shape correction pattern image. It should be noted that the shape correction unit 240 performs the shape correction process together with the element controller 260 or the projection unit controller 270. That is, the shape correction unit 240 calculates a correction parameter necessary for the shape correction process, and outputs the calculated parameter to the element controller 260 or the projection unit controller 270.

Specifically, the shape correction unit 240 specifies the characteristic point contained in the picked-up image based on the picked-up image of the shape correction pattern image that is acquired by the acquisition unit 230. More specifically, the shape correction unit 240 has a filter for extracting a feature (luminance, chroma, or hue) of surrounding pixels arranged around the target pixel. This filter extracts a pixel for specifying adjacent regions defining the characteristic point, from the surrounding pixels.

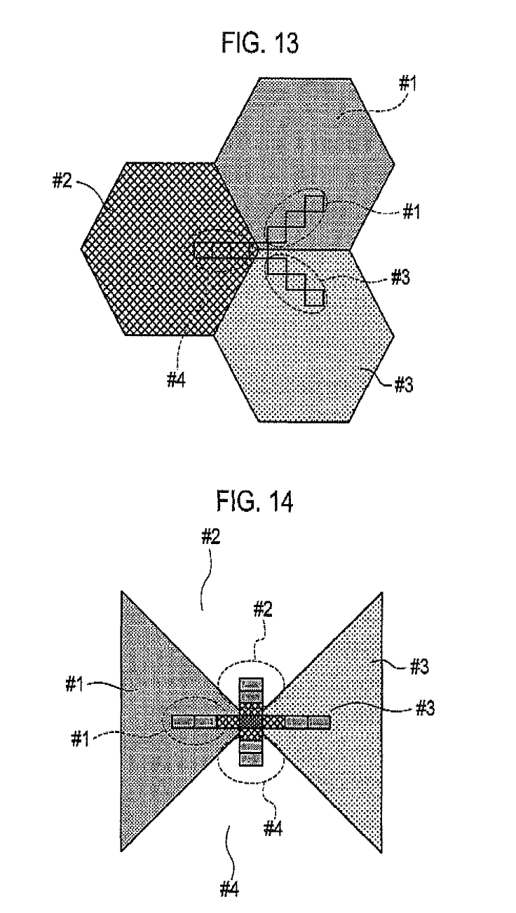

For example, if the shape correction pattern image is the image of FIG. 9, then the filter of the shape correction unit 240 extracts a predetermined number of pixels in the obliquely upper right relative to the target pixel, a predetermined number of pixels in the obliquely lower right relative to the target pixel, and a predetermined number of pixels in the left to the target pixel, as illustrated in FIG. 13. Alternately, if the shape correction pattern image is the image of FIG. 10, then the filter of the shape correction unit 240 extracts a predetermined number of pixels aligned in the upper, down, right, and left directions relative to the target pixel, as illustrated in FIG. 14.

The shape correction unit 240 sets the pixels forming the picked-up image acquired by the acquisition unit 230 as the target pixel. Then, the shape correction unit 240 applies the filter to the target pixel thereby to determine whether the target pixel is the characteristic point or not. In other words, the shape correction unit 240 determines whether or not a pattern acquired by applying the filter (detected pattern) is a predetermined pattern defining the characteristic point.

The shape correction unit 240 calculates a correction parameter for adjusting the image projected on the projection plane 400, based on the arrangement of the specified characteristic point.

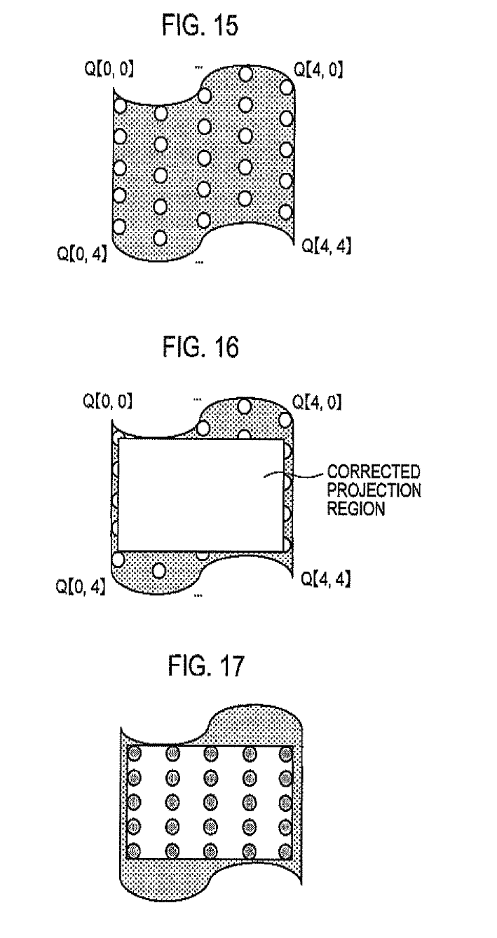

First, the shape correction unit 240 acquires the arrangement of the characteristic points (characteristic point map) specified by the shape correction unit 240, as illustrated in FIG. 15,

Second, the shape correction unit 240 extracts, from the characteristic point map illustrated in FIG. 15, a region in which an image can be projected without causing any distortions (corrected projection region), as illustrated in FIG. 16. Note that the characteristic point map illustrated in FIG. 15 is produced based on the picked-up image imaged by the image pick-up element 300, and therefore, the corrected projection region is a region in which the image can be projected without any distortions, as seen from the position of the image pick-up element 300.

Third, the shape correction unit 240 calculates the correction parameter for correctly arranging the characteristic points in the corrected projection region, as illustrated in FIG. 17. In other words, the correction parameter is a parameter for adjusting the locations of each characteristic point contained in the characteristic point map so that the coordinates (relative locations) of each characteristic point contained in the shape correction pattern image stored in the storage unit 220 are satisfied.

Fourth, the shape correction unit 240 calculates the correction parameter for a pixel contained in a region defined by the four characteristic points. Specifically, the shape correction unit 240 calculates the correction parameter on the assumption that the region surrounded by the four characteristic points is a pseudo plane.

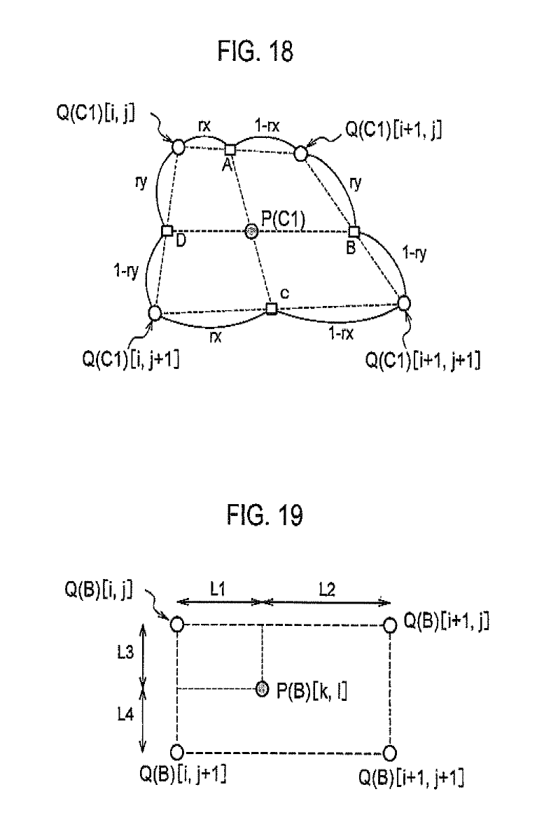

For example, the following case is described: the correction parameter for a pixel P(C1) contained in a region surrounded by the four characteristic points is calculated, where the four characteristic points contained in the picked-up image captured by the image pick-up element 300 are represented by Q(C1)[i, j], Q(C1)[i+1, j], Q(C1)[i, j+1], and Q(C1)[i+1, j+1), as illustrated in FIG. 18. In this case, in the shape correction pattern image stored in the storage unit 220, pixels which correspond to Q(C1)[i, j], Q(C1)[i+1, j], Q(C1)[i, j+1], Q(C1)[i+1, j+1] and P (C1) are represented by Q(B)[i, j], Q(B)[i+1,j], Q(B)[i, j+1], Q(B)[i+1, j+1] and P(B)[k, l], respectively, as illustrated in FIG. 19. Note that the coordinates at Q(B)[i, j], Q(B)[i+1, j], Q(B)[i, j+1], Q(B)[i+1, j+1], and P(B)[k, l] are known. In such a case, the coordinates at P(C1) can be calculated based on the coordinates at Q(C1)[i, j], Q(C1)[i+1, j), Q(C1)[i, j+1], and Q(C1)[i+1, j+1] and an internal ratio (rx, ry). The internal ratio (rx, ry) is expressed by the following equations:

rx=L1/(L1+L2)

ry=L3/(L3+L4)

Returning to FIG. 7, the coordinate calibration unit 250 performs the coordinate conversion associated with the interactive function.

First, the coordinate calibration unit 250 performs an interactive calibration process for projecting the calibration pattern image on the projection plane 400 and associating the coordinates of the picked-up image that is captured by the image pick-up element 300 and the coordinates of the image projected on the projection plane 400 with each other, based on the picked-up image of the calibration pattern image.

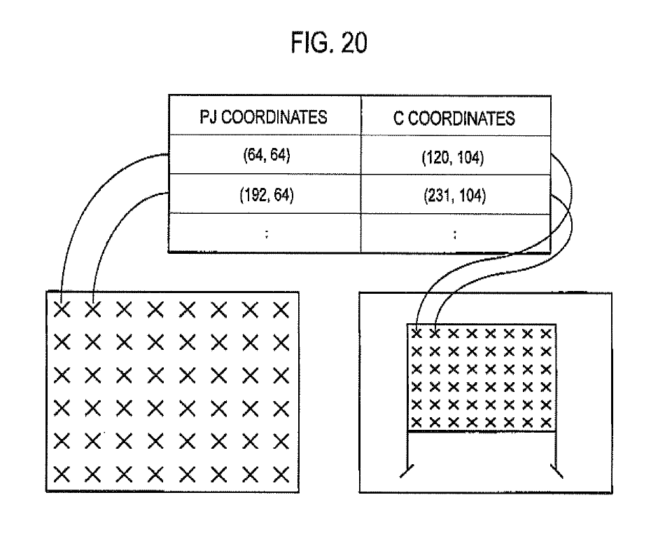

In particular, as illustrated in FIG. 20, the coordinate calibration unit 250 associates the coordinates (C coordinates) of the characteristic points that are contained in the picked-up image of the calibration pattern image with the coordinates (PJ coordinates) of the image projected on the projection plane 400. It should be noted that the PJ coordinates corresponding to the characteristic points contained in the picked-up image of the calibration pattern image are known. Moreover, the PJ coordinates are the same as the coordinates managed by the projection display apparatus 100 and the external device 500, as described above.

It should be also noted that the interactive calibration process is performed after the shape correction process in the first embodiment.

When the calibration pattern image is the same as the shape correction pattern image, if the correction amount of the shape of an image projected on the projection plane 400 is equal to or less than a predetermined threshold value, then the projection display apparatus 100 may skip the projection of the calibration pattern image during the interactive calibration process.

Second, the coordinate calibration unit 250 converts the coordinates indicated by the electronic pen 450 (i.e, the C coordinates of an infrared light beam in the picked-up image) into the PJ coordinates, based on the association between the C coordinates and the PJ coordinates. The coordinate calibration unit 250 outputs the coordinates indicated by the electronic pen 450 (i.e., the PJ coordinates of the infrared light beam), to the external device 500.

Herein, a description will be given of a method for converting the coordinates X indicated by the electronic pen 450 in the C coordinates space into coordinates X′ indicated by the electronic pen 450 in the PJ coordinates space.

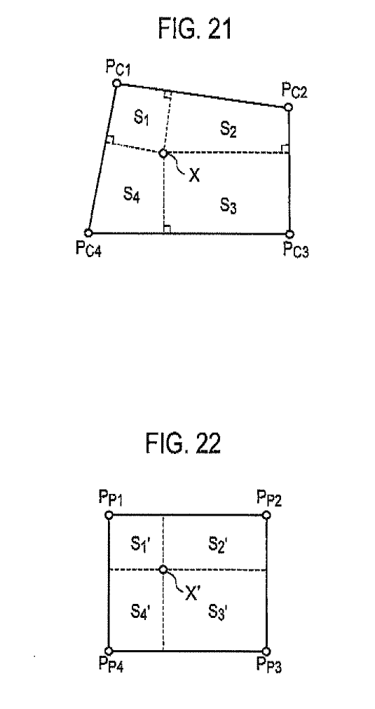

In particular, the coordinate calibration unit 250 specifies known coordinates (P_{C1} to P_{C4}) arranged around the coordinates X, in the C coordinates space, as illustrated in FIG. 21. Further, the coordinate calibration unit 250 specifies coordinates (F_{P1} to P_{P4}) corresponding to the known coordinates (P_{C1} to P_{C4}), in the FJ coordinates space, as illustrated in FIG. 22. The coordinate calibration unit 250 specifies the coordinates X′ such that the proportion of areas S′₁ to S′₄ defined by the coordinates X′ and P_{P1} to P_{P4} is equal to that of areas S₁ to S₄ defined by the coordinates X and P_{C1} to P_{C4}.

Returning to FIG. 7, the element controller 260 converts the image input signal into the image output signal, and controls the liquid crystal panel 50 based on the image output signal. Specifically, the element controller 260 automatically corrects the shape of an image projected on the projection plane 400, based on the correction parameter output from the shape correction unit 240. That is, the element controller 260 includes a function of automatically performing a shape correction based on the position relationship between the projection display apparatus 100 and the projection plane 400.

The projection unit controller 270 controls the lens group arranged in the projection unit 110. First, the projection controller 270 controls such that the projectable range 410 remains within a display frame 420 arranged on the projection plane 400, by shifting a lens group arranged in the projection unit 110 (zoom adjustment process). The projection unit controller 270 adjusts the focus of the image projected on the projection plane 400 by shifting the lens group arranged in the projection unit 110 (focus adjustment process),

### (Operation of Projection Display Apparatus)

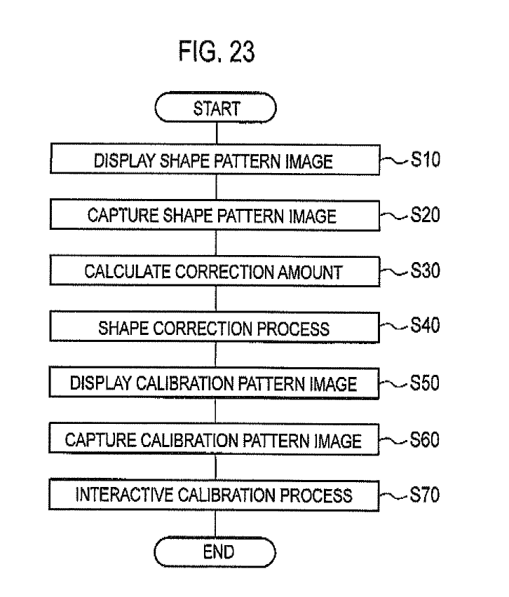

Hereinafter, the operation of the projection display apparatus (control unit) according to the first embodiment is described with reference to drawings. FIG. 23 to FIG. 25 are flowcharts each illustrating the operation of the projection display apparatus 100 (control unit 200) according to the first embodiment.

First, the description will be given of a case where the shape correction pattern image is different from the calibration pattern image, with reference to FIG. 23.

As illustrated in FIG. 23, in step 10, the projection display apparatus 100 displays (projects) the shape correction pattern image onto the projection plane 400.

In step 20, the projection display apparatus 100 acquires the picked-up image of the shape correction pattern image from the image pick-up element 300.

In step 30, the projection display apparatus 100 extracts the characteristic points by means of pattern matching, and then, calculates the correction parameter. In other words, the projection display apparatus 100 calculates a correction amount of the shape of the image projected on the projection plane 400.

In step 40, the projection display apparatus 100 performs the shape correction process based on the correction parameter calculated in step 30.

In step 50, the projection display apparatus 100 displays (projects) the calibration pattern image on the projection plane 400.

In step 60, the projection display apparatus 100 acquires the picked-up image of the calibration pattern image from the image pick-up element 300.

In step 70, the projection display apparatus 100 performs the interactive calibration process. Specifically, the projection display apparatus 100 associates the coordinates (C coordinates) of the characteristic points contained in the picked-up image of the calibration pattern image with the coordinates (N coordinates) of the image projected on the projection plane 400.

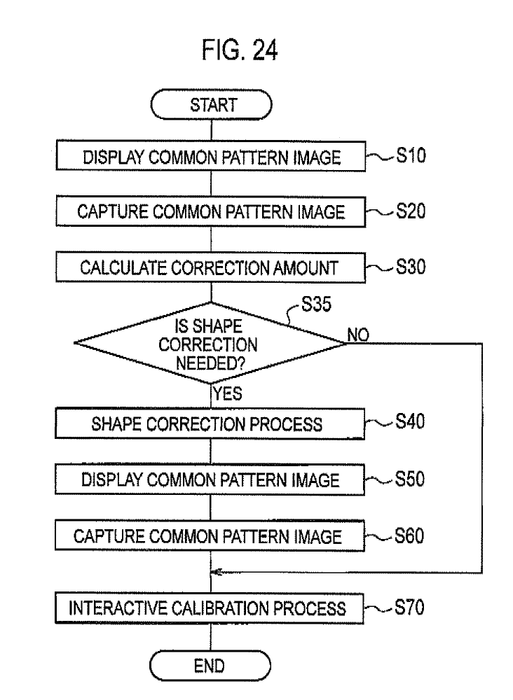

Second, the description will be given of a case where the calibration pattern image is the same as the shape correction pattern image, with reference to FIG. 24. In this case, an image that is used both in the shape correction pattern image and in the calibration pattern image is called “common pattern image”. In FIG. 24, like step numbers are assigned to like steps in FIG. 23. Like steps in FIG. 23 are not described.

As illustrated in FIG. 24, in step 35, the projection display apparatus 100 determines whether it is necessary to correct the shape of an image projected on the projection plane 400. Specifically, the projection display apparatus 100 determines whether or not the correction amount of the shape of the image projected on the projection plane 400 is equal to or less than a predetermined threshold value. When it is necessary to correct the shape of the image (i.e., when the correction amount exceeds a predetermined threshold value), the projection display apparatus 100 moves to the process in step 40. On the other hand, when it is not necessary to correct the shape of the image (i.e., when the correction amount is equal to or less than the predetermined threshold value), the projection display apparatus 100 skips the processes in steps 40 to 60 and moves to a process in step 70.

That is, the projection display apparatus 100 skips the projection of the common pattern image (calibration pattern image), but performs, in step 70, the interactive calibration process, based on the picked-up image of the common pattern image (shape correction pattern image) which has been captured in step 20.

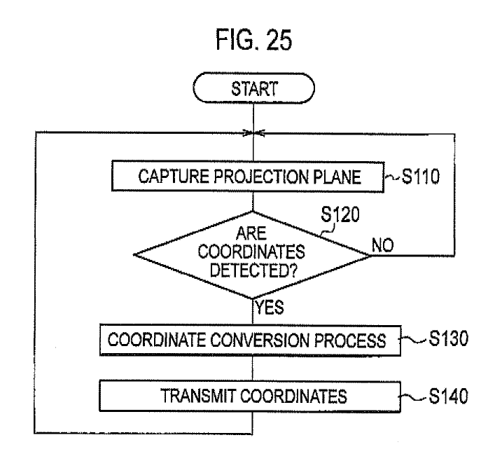

Third, a description will be given of a conversion of coordinates of an infrared light beam emitted from the electronic pen 450, with reference to FIG. 25.

As illustrated in FIG. 25, in step 110, the projection display apparatus 100 acquires a picked-up image of the projection plane 400 from the image pick-up element 300.

In step 120, the projection display apparatus 100 determines whether or not the C coordinates of the infrared light beam emitted from the electronic pen 450 have been detected. If the C coordinates of the infrared light beam have been detected, then the projection display apparatus 100 moves to a process in step 120. If the C coordinates of the infrared light beam have not been detected, then the projection display apparatus 100 returns to the process in step 110.

In step 120, the projection display apparatus 100 converts the C coordinates of the infrared light beam into the PJ coordinates, based on the association between the C coordinates and the PJ coordinates.

In step 130, the projection display apparatus 100 outputs the PJ coordinates of the infrared light beam to the external device 500.

### (Operation and Effect)

In the first embodiment, since the interactive calibration process is performed after the shape correction process, it is possible to prevent the collapse of the association between the coordinates (C coordinates) of the picked-up image captured by the image pick-up element and the coordinates (PJ coordinates) of the image projected on the projection plane.

In the first embodiment, the common pattern image is used both in the shape correction pattern image and the calibration pattern image, and when the correction amount of the shape of the image projected on the projection plane 400 is equal to or less than a predetermined threshold value, the projection of the common pattern image (calibration pattern image) is skipped. By skipping the re-projection of the common pattern image as described above, the processing load of the projection display apparatus 100 and a waiting time of the interactive calibration process are lessened.

In the first embodiment, in the shape correction pattern image, the characteristic point is defined by at least three adjacent regions. In other words, the characteristic point is defined by a combination of at least three adjacent regions. Accordingly, if types of the features for example, hue or luminance) that define the characteristic point are equal in number, then it is possible to increase the number of definable characteristic points than a case where a single characteristic point is defined by a single feature. Therefore, even when the number of characteristic points is large, it is possible to easily detect each characteristic point.

### [First Modification]

Hereinafter, a first modification of the first embodiment is explained. Mainly the differences from the first embodiment are described, below.

In the first modification, the coordinate calibration unit 250 performs a simple interactive calibration process for projecting a simple calibration pattern image on the projection plane 400, and associating the coordinates of a picked-up image captured by the image pick-up element 300 and coordinates of an image projected on the projection plane 400 with each other, based on the picked-up image of the simple calibration pattern image. The coordinate calibration unit 250 performs the simple interactive calibration process, when a change amount of the attitude of the projection display apparatus 100 falls within an acceptable range.

### (Configuration of Control Unit)

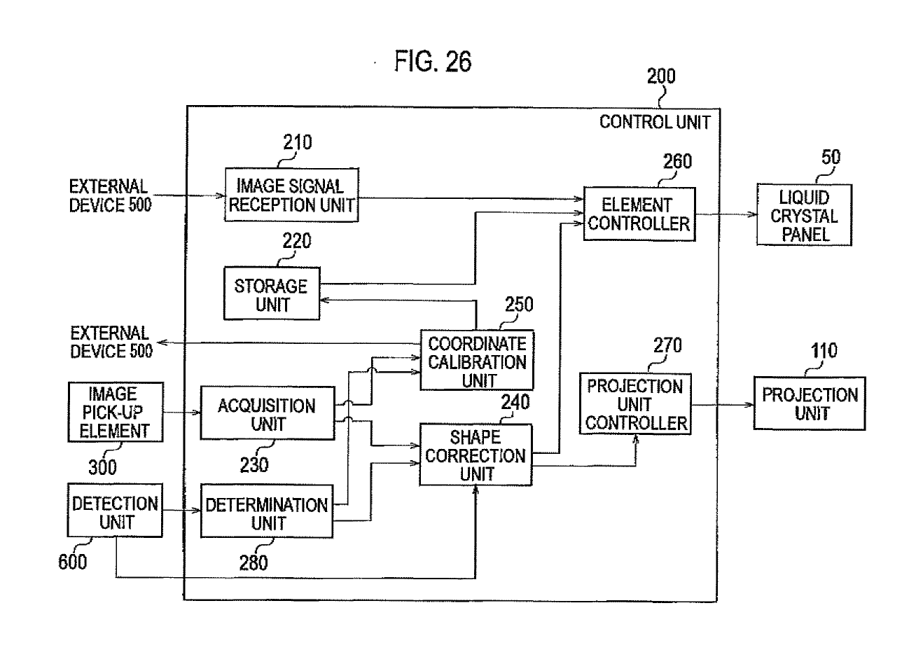

Hereinafter, the control unit according to the first modification will be described with reference to the accompanying drawings. FIG. 26 is a block diagram illustrating the control unit 200 according to the first modification.

In FIG. 26, the control unit 200 includes a determination unit 280, in addition to the configuration illustrated in FIG. 7.

The control unit 200 is connected to a detection unit 600. This detection unit 600 detects a change amount of the attitude of the projection display apparatus 100. The detection unit 600 may be, for example, a gyro sensor for detecting a change amount of a tilt angle or a change amount of a pan angle.

The determination unit 280 determines whether or not the change amount of the attitude of the projection display apparatus 100 falls within an acceptable range. In other words, the determination unit 280 determines whether or not the shape of an image projected on the projection plane 400 can be corrected, based on the detection result of the detection unit 600.

The above-described storage unit 220 stores the simple calibration pattern image. A region in which the simple calibration pattern image is displayed is smaller than that of the calibration pattern image.

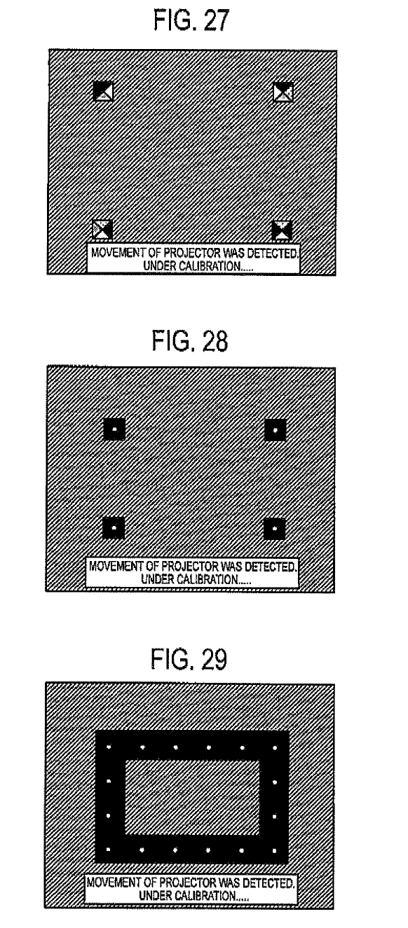

Herein, as illustrated in FIG. 27, for example, the simple calibration pattern image is a part of the calibration pattern image illustrated in FIG. 8. For example, the simple calibration pattern image is an image in which at least four characteristic points can be specified.

Alternately, as illustrated in FIG. 28, the simple calibration pattern image is a part of the calibration pattern image illustrated in FIG. 11. For example, the simple calibration pattern image is an image in which at least four characteristic points can be specified.

Alternately, as illustrated in FIG. 29, the simple calibration pattern image is a part of the calibration pattern image illustrated in FIG. 12. Alternately, the simple calibration pattern image may be any image in a particular step, illustrated in FIG. 12, of the calibration pattern images.

If the change amount of the attitude of the projection display apparatus 100 falls within the acceptable range, then the shape correction unit 240 corrects the shape of the image projected on the projection plane 400, based on the detection result of the detection unit 600. On the other hand, if the change amount of the attitude of the projection display apparatus 100 falls outside the acceptable range, then the shape correction unit 240 performs the shape correction process.

The above-described coordinate calibration unit 250 performs a simple interactive calibration process for projecting a simple calibration pattern image on the projection plane 400, and associating the coordinates of a picked-up image captured by the image pick-up element 300 and the coordinates of an image projected on the projection plane 400 with each other, based on the picked-up image of the simple calibration pattern image.

Specifically, the coordinate calibration unit 250 performs the simple interactive calibration process, when the change amount of the attitude of the projection display apparatus 100 falls within an acceptable range. On the other hand, the coordinate calibration unit 250 performs the interactive calibration process, when the change amount of the attitude of the projection display apparatus 100 falls outside an acceptable range.

### (Operation of Projection Display Apparatus)

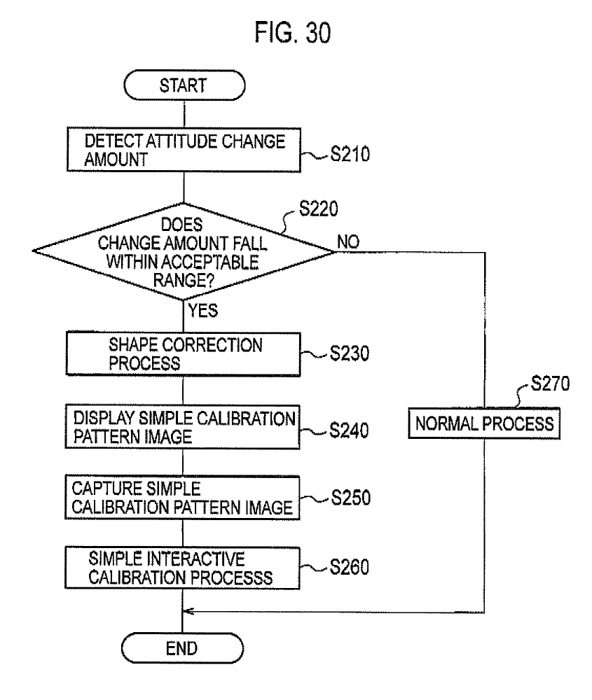

Hereinafter, the operation of the projection display apparatus (control unit) according to the first modification is described with reference to drawings. FIG. 30 is a flowchart illustrating the operation of the projection display apparatus 100 (control unit 200) according to the first modification.

As illustrated in FIG. 30, in step 210, the projection display apparatus 100 detects a change amount of the attitude of the projection display apparatus 100.

In step 220, the projection display apparatus 100 determines whether or not the change amount of the attitude of the projection display apparatus 100 falls within an acceptable range. If the change amount of the attitude falls within the acceptable range, then the projection display apparatus 100 moves to a process in step 230. On the other hand, if the change amount of the attitude falls outside the acceptable range, then the projection display apparatus 100 moves to a process in step 270.

In step 230, the projection display apparatus 100 corrects the shape of the image projected on the projection plane 400, based on the detection result of the detection unit 600.

In step 240, the projection display apparatus 100 displays (projects) the simple calibration pattern image on the projection plane 400.

In step 250, the projection display apparatus 100 acquires the picked-up image of the simple calibration pattern image from the image pick-up element 300.

In step 260, the projection display apparatus 100 performs the simple interactive calibration process. In particular, the projection display apparatus 100 associates the coordinates (C coordinates) of the characteristic points contained in the picked-up image of the simple calibration pattern image with the coordinates (PJ coordinates) of the image projected on the projection plane 400.

In step 270, the projection display apparatus 100 performs the shape correction process and the interactive calibration process (see the flowchart in FIG. 24 or FIG. 25).

Note that when determining in step 220 that the correction of the shape of the image projected on the projection plane 400 is unnecessary, the processes from step 230 to 270 may be skipped.

### (Operation and Effect)

In the first modification, the coordinate calibration unit 250 performs the simple interactive calibration process, when the change amount of the attitude of the projection display apparatus 100 falls within an acceptable range. Therefore, it is possible to reduce the processing load of the projection display apparatus 100.

### [Second Modification]

Hereinafter, a second modification of the first embodiment is explained. Mainly the differences from the first embodiment are described, below.

In the second modification, the shape correction unit 240 performs a simple shape correction process for projecting the simple shape correction pattern image on the projection plane 400, and correcting the shape of the image projected on the projection plane 400, based on the picked-up image of the simple shape correction pattern image. The coordinate calibration unit 250 performs the simple interactive calibration process, when the correction amount of the simple shape correction process falls within an acceptable range.

Note that a region in which the simple shape correction pattern image is displayed is less than a region in which the shape correction pattern image is displayed. The simple shape correction pattern image may be different from the simple calibration pattern image. In addition, the simple shape correction pattern image may be the same as the simple calibration pattern image.

### (Operation of Projection Display Apparatus)

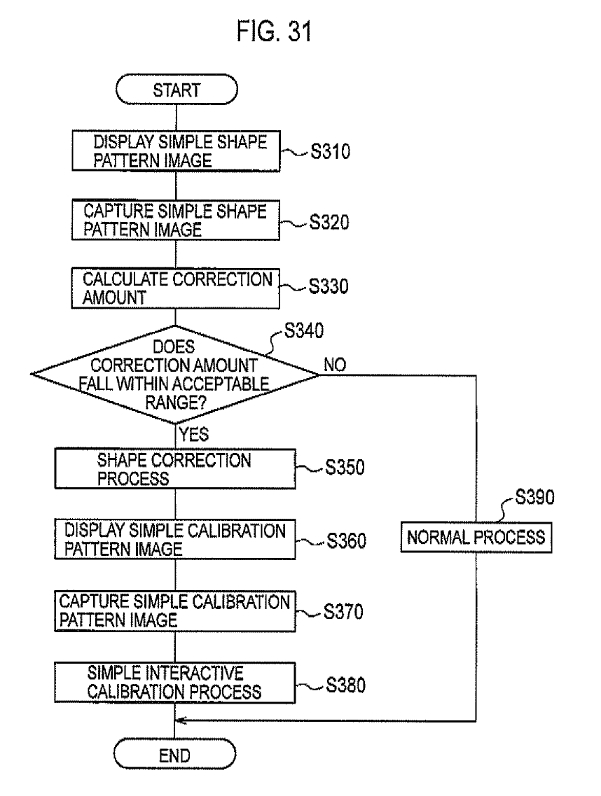

Hereinafter, the operation of the projection display apparatus (control unit) according to the second modification is described with reference to drawings. FIG. 31 is a flowchart illustrating the operation of the projection display apparatus 100 (control unit 200) according to the second modification.

As illustrated in FIG. 31, in step 310, the projection display apparatus 100 displays (projects) the simple shape correction pattern image onto the projection plane 400.

In step 320, the projection display apparatus 100 acquires the picked-up image of the simple shape correction pattern image from the image pick-up element 300.

In step 330, the projection display apparatus 100 extracts the characteristic points by means of pattern matching, and then, calculates the correction parameter. In other words, the projection display apparatus 100 calculates a correction amount of the shape of the image projected on the projection plane 400.

In step 340, the projection display apparatus 100 determines whether or not the correction amount of the simple shape correction process falls within an acceptable range. If the correction amount falls within the acceptable range, then the projection display apparatus 100 moves to a process in step 350. On the other hand, if the correction amount falls outside the acceptable range, then the projection display apparatus 100 moves to a process in step 390.

In step 350, the projection display apparatus 100 performs the simple shape correction process, based on the correction parameter calculated in step 330.

In step 360, the projection display apparatus 100 displays (projects) the simple calibration pattern image on the projection plane 400.

In step 370, the projection display apparatus 100 acquires the picked-up image of the simple calibration pattern image from the image pick-up element 300.

In step 380, the projection display apparatus 100 performs the simple interactive calibration process. In particular, the projection display apparatus 100 associates the coordinates (C coordinates) of the characteristic points contained in the picked-up image of the simple calibration pattern image with the coordinates (PJ coordinates) of the image projected on the projection plane 400.

In step 390, the projection display apparatus 100 performs the shape correction process and the interactive calibration process (see the flowchart in FIG. 24 or FIG. 25).

Note that when determining in step 340 that the correction of the shape of the image projected on the projection plane 400 is unnecessary, the processes from step 350 to 390 may be skipped.

In the first modification, the coordinate calibration unit 250 performs the simple interactive calibration process, when the correction amount of the simple shape correction process falls within an acceptable range. Therefore, it is possible to reduce the processing load of the projection display apparatus 100.

### Other Embodiments

The present invention is explained through the above embodiments, but it must not be assumed that this invention is limited by the statements and drawings constituting a part of this disclosure. From this disclosure, various alternative embodiments, examples, and operational technologies will become apparent to those skilled in the art.

In the aforementioned embodiment, the white light source is illustrated as an example of the light source. However, the light source may be LED (Light Emitting Diode) or LD (Laser Diode).

In the aforementioned embodiment, the transmissive liquid crystal panel is illustrated as an example of the imager. However, the imager may be a reflective liquid crystal panel or DMD (Digital Micromirror Device).

Although no particular mention has been made in the embodiment, any given image may be superimposed on the calibration pattern image, in the region except for the image in which a plurality of known coordinates can be specified. In this case, any given image is input from, for example, the external device 500. For example, any given image is superimposed on a shaded area of the simple calibration pattern images that are illustrated in FIG. 27 to FIG. 29.

1. A projection display apparatus comprising: an imager that modulates light emitted from a light source; and a projection unit that projects the light emitted from the imager on a projection plane, the apparatus comprising;
an acquisition unit that acquires a picked-up image of an image projected on the projection plane from an image pick-up element that captures the image projected on the projection plane;
a shape correction unit that performs a shape correction process for projecting a shape correction pattern image on the projection plane, calculating shape correction values from the picked-up image of the shape correction pattern image, and correcting the shape of the image projected on the projection plane, based on the shape correction values; and
a coordinate calibration unit that performs an interactive calibration process for projecting a calibration pattern image on the projection plane, calculating calibration correction values from the picked-up image of the calibration pattern image, associating coordinates of the picked-up image captured by the image pick-up element and coordinates of the image projected on the projection plane with each other, based on calibration correction values, wherein
the interactive calibration process is performed after the shape correction process.

2. The projection display apparatus according to claim 1, wherein
the calibration pattern image includes an image in which a plurality of known coordinates can be specified, in the image projected on the projection plane, and
the plurality of known coordinates are dispersed separately from one another.

3. The projection display apparatus according to claim 2, wherein another image is superimposed on the calibration pattern image, in a region except for the image in which a plurality of known coordinates can be specified.

4. The projection display apparatus according to claim 1, wherein
the calibration pattern image is the same as the shape correction pattern image, and
the coordinate calibration unit skips projection of the calibration pattern image during the interactive calibration process, when a correction amount of the shape of an image projected on the projection plane is equal to or less than a predetermined threshold value.

5. The projection display apparatus according to claim 1, wherein
when a change amount of the attitude of the projection display apparatus falls within an acceptable range, the coordinate calibration unit performs a simple interactive calibration process for projecting a simple calibration pattern image on the projection plane, calculating calibration correction values from the picked-up image of the calibration pattern image, associating coordinates of the picked-up image captured by the image pick-up element and coordinates of the image projected on the projection plane with each other, based on calibration correction values, and
a region where the simple calibration pattern image is displayed is less than a region where the calibration pattern image is displayed.

6. The projection display apparatus according to claim 1, wherein
the shape correction unit performs a simple shape correction process for projecting a simple shape correction pattern in on the projection plane, calculating shape correction values from the picked-up image of the shape correction pattern image, and correcting the shape of the image projected on the projection plane, based on the shape correction values,
when a correction amount of the simple shape correction process falls within an acceptable range, the coordinate calibration unit performs a simple interactive calibration process for projecting a simple calibration pattern image on the projection plane, calculating calibration correction values from the picked-up image of the calibration pattern image, associating coordinates of the picked-up image captured by the image pick-up element and coordinates of the image projected on the projection plane with each other, based on calibration correction values,
a region where the simple shape correction pattern image is displayed is less than a region where the shape correction pattern image is displayed, and
a region where the simple calibration pattern image is displayed is less than a region where the calibration pattern image is displayed.
